(19) United States
(12) Patent Application Publication
(10) Pub. No.: US 2008/0205275 A1
(43) Pub. Date: Aug. 28, 2008

(54) Communication Resource Scheduling

(76) Inventors: Mikko Rinne, Espoo (FI); Pirjo Pasanen, Vantaa (FI)

Correspondence Address: ROBERT M BAUER, ESQ.;MacDonald Illig Jones & Britton LLP, Suite 700, 100 State Street, Erie, PA, 16507-1459, US

(21) Appl. No.: 11/718,918

(22) PCT Filed: May 17, 2005
(86) PCT No.: PCT/FI2005/000223

§ 371 Date: Nov. 8, 2007

(30) Foreign Application Priority Data
Nov. 15, 2004 (FI) 20041465

(51) Int. Cl. G08C 15/00

(52) U.S. Cl. 370/235

(57) ABSTRACT

In a method for scheduling communication resources, data-flow-specific information relating to a next scheduling period for a set of data flows is determined in a first entity. The determined data-flow-specific information is submitted to a second entity, where communication resource properties for communication resources are estimated. Communication resources in the next scheduling period are allocated in the second entity based at least on said data-flow-specific information and said communication resource properties.

### BACKGROUND OF THE INVENTION

1. Field of the Invention

The present invention relates to scheduling of communication resources in a communications system.

2. Description of the Related Art

A communication system can be seen as a facility that enables communication between two or more entities such as user equipment and/or other nodes associated with the system. The communication may comprise, for example, communication of voice, data, multimedia and so on. The communication system may be circuit switched or packet switched. The communication system may be configured to provide wireless communication.

There may be a number of users who wish to use communication resources of a communication system. Typically the number of active users may change over time, and the amount of data to be transmitted may be very different from one user to another. Furthermore, the users may pose different quality requirements on data transmission. These requirements may relate, for example, to a transmission delay or to occurrence of transmission errors.

The communication resources need to be divided between these users, preferably taking into account the user-specific amounts of data to be transmitted and quality requirements. The allocation of the resources to different users can be done in time, frequency, code or spatial dimensions. Scheduling refers to time multiplexing communication resources across multiple active users. Typically communication resources are allocated to users in consequent scheduling periods. The users and the number of users, for whom communication resources are allocated, typically change from one scheduling period to another.

Communication resource scheduling in radio systems is a widely researched domain with a multitude of available solutions and variants. A good scheduler is fair, while maximizing the radio interface efficiency. These two requirements are often contradictory, as can be seen in the deficiencies of two basic scheduler examples.

A round-robin scheduler, in the basic form, gives an equal amount of time for each user who has data to transmit. This scheduler is always fair, but if it is applied to systems with link adaptation, it results in poor air interface efficiency. The poor air interface efficiency is due to the following. Link adaptation allows choosing of transmission method, for example, a coding scheme and a modulation alphabet for the transmission, based on the quality of the allocated radio channel. With link adaptation, it is thus possible to use a higher data rate on a radio channel having good quality and a lower data rate on a worse-quality radio channel. The overall radio interface efficiency would therefore benefit from taking users' channel qualities into account in scheduling. By allocating equal amounts of time for each user, the round-robin scheduler is insensitive to the quality of radio channels.

A second example of a scheduler is based on maximum carrier to interference ratio (C/I). This scheduler prioritizes the user who has the best communication channel in the scheduling period, and in many cases this scheduler gives the benchmark for data throughput. The maximum C/I scheduler is not usable in the basic configuration, because it does not allocate any communication resources to user with inferior communication channels.

A well-known and studied attempt to improve over these basic scheduling schemes is the proportional fairness scheduler. This scheduler has been incorporated into 1xEV-DO by Qualcomm, and it is discussed by A. Jalali, R. Padovani, and R. Pankaj, in “Data Throughput of CDMA-HDR: A High-Efficiency High-Data Rate Personal Communication Wireless System,” Proceedings of the IEEE VTC, 2000.

The proportional fairness scheduler is based on the following ideas. For each user, an estimate of the channel quality (for example, C/I) is calculated and a sliding average of the channel quality is separately computed in a water-filling fashion. The instantaneous channel quality is divided with the average channel quality, and the user with the highest ratio at any given time instant gets the communication resource. This approach succeeds in giving the communication resource to users when their channel is better than average, but due to wireless channel characteristics it favors users who are physically moving fast.

It is appreciated that both the maximum C/I scheduler and the proportional fairness scheduler rely on the idea that there is a channel quality measure for each user. Also other traditional scheduling solutions rely on a single quality metric for the quality of the communication channel between a transmitter and a receiver.

In modern wireless systems multiple means are exploited to increase the throughput, for example by using multiple parallel data streams or by obtaining better error performance from diversity. For example, multiple antennas and/or multicarrier transmission over a wide transmission bandwidth may be used to create multiple parallel channels between the transmitter and the receiver. In these wireless systems, the channel characteristics between a transmitter and receiver can be different for different parts of the transmission medium. The channel from one antenna branch can be excellent, while the channel form another antenna branch is deeply faded. A group of subcarriers allocated to a user can be excellent, while another group of subcarriers allocated to the same user is performing badly.

It is possible to measure characteristics of different antenna branches, for example. Communication resource scheduling should therefore be able to take into account all measured channel information, not just one quality metric, for efficiently scheduling the communication resources.

A problem is, however, that scheduling requires information about the communication resource properties and about the requirements the users pose on the data transmission. All this information needs to be communicated to the scheduler. Typically channel properties are measured in the physical layer (L1), whereas the link layer (L2) knows at least some quality requirements. In a radio system, where multiple transmission channels are offered on the physical layer and comprehensive quality of service (QoS) provision mechanisms are offered towards the higher layers, a large amount of parameters need to be transported across protocol layers to the layer responsible for scheduling. This results in increased interlayer communications which increases complexity in specifications and implementation and can, depending on implementation architecture, also cause extra delay. Furthermore, a single scheduling algorithm becomes complex, if it needs to take into account all measured channel property information and QoS requirements. Such a complex scheduler increases processing power requirements for the processor on which the scheduler is run.

### SUMMARY OF THE INVENTION

Embodiments of the present invention aim to provide communication resource scheduling which may be used with various types of communication resources and which is able to take into account available information about communications resources quality and quality requirements.

A first aspect of the invention provides a method for scheduling communication resources, the method comprising
determining data-flow-specific information relating to a next scheduling period for a set of data flows in a first entity,
submitting said data-flow-specific information to a second entity,
estimating communication resource properties for communication resources in said second entity, and
   allocating said communication resources in the next scheduling period based at least on said data-flow-specific information and said communication resource properties in said second entity.

A second aspect of the invention provides a method for scheduling communication resources, the method comprising
determining data-flow-specific information relating to a next scheduling period for a set of data flows, and
submitting said data flow-specific information to a further entity for allocating communication resources in the next scheduling period in said further entity based at least on said data-flow-specific information and on estimated properties of said communication resources.

A third aspect of the invention provides a method for scheduling communication resources, the method comprising
receiving from a further entity data-flow-specific information relating to a next scheduling period for a set of data flows,
   estimating communication resource properties for communication resources, and
   allocating said communication resources in the next scheduling period based at least on said data-flow-specific information and said communication resource properties.

A fourth aspect of the invention provides a device for scheduling communication resources, said device being configured to
determine data-flow-specific information relating to a next scheduling period for a set of data flows in a first entity,
submit said data flow-specific information to a second entity,
estimate communication resource properties in communication resources in the second entity, and
allocate said communication resources in the next scheduling period based at least on said data-flow-specific information and said communication resource properties in the second entity.

A fifth aspect of the invention provides a communications system configured to
determine data-flow-specific information relating to a next scheduling period for a set of data flows in a first entity,
submit said data-flow-specific information to a second entity,
estimate communication resource properties for communication resources in the second entity, and
allocate said communication resources in the next scheduling period based at least on said data-flow-specific information and said communication resource properties in the second entity.

A sixth aspect of the invention provides a device for scheduling communication resources, said device being configured to
receive from a further entity data-flow-specific information relating to a next scheduling period for a set of data flows,
estimate communication resource properties for communication resources, and
allocate said communication resources in the next scheduling period based at least on said data-flow-specific information and said communication resource properties.

A seventh aspect of the invention provides a device for scheduling communication resources, said device being configured to
determine data-flow-specific information relating to a next scheduling period for a set of data flows, and
submit said data-flow-specific information to a further entity for allocating communication resources in the next scheduling period in said further entity based at least on said data-flow-specific information and on estimated properties of said communication resources.

An eighth aspect of the invention provides a computer program comprising program instructions for causing a computing device to perform a method in accordance with the invention.

A ninth aspect of the invention provides a method for scheduling communication resources, the method comprising
determining data-flow-specific information relating to a next scheduling period for a set of data flows,
estimating communication resource properties for communication resources, and
allocating said communication resources in the next scheduling period based at least on said data-flow-specific information and said communication resource properties.

A tenth aspect of the invention provides a device configured to
determine data-flow-specific information relating to a next scheduling period for a set of data flows,
estimate communication resource properties for communication resources, and
allocate said communication resources in the next scheduling period based at least on said data-flow-specific information and said communication resource properties.

### BRIEF DESCRIPTION OF THE DRAWINGS

Embodiments of the present invention will now be described by way of example only with reference to the accompanying drawings, in which:

FIG. 1a shows a schematic block diagram of a first embodiment of the invention;

FIG. 1b shows a schematic block diagram of a first alternative of the first embodiment of the invention;

FIG. 1c shows a schematic block diagram of a second alternative of the first embodiment of the invention;

FIG. 2 shows, as an example, a schematic diagram of two lowest protocol layers L1 and L2 in accordance with a second embodiment of the invention;

FIG. 3 shows, as an example, a flowchart of a method in accordance with a third embodiment of the invention;

FIGS. 4A and 4B show, as an example, a flowchart of a method in accordance with a fourth embodiment of the invention; and

FIG. 5 shows, as an example, a restricted version of the scheduler functionality implemented in a communications device.

### DETAILED DESCRIPTION OF THE EMBODIMENTS

Scheduling of communication resources in the following description and in the appended claims refers to time multiplexing communication resources to active data flows. A user may have multiple data flows. The number of active data flows typically changes over time. Scheduling is typically performed by allocating communication resources to data flows in consecutive scheduling periods. Multiple data flows may be scheduled to transmit during a scheduling period. In this description and in the appended claims, a scheduling period typically refers to a duration of time for which physical communication resource allocations are signaled jointly.

It is appreciated that the duration of the scheduling periods is typically constant, but it is possible that the duration of the scheduling periods varies over time.

The set of data flows, to which communication resources are allocated in a first scheduling period, may be different than the set of data flows, to which communication resources are allocated in a second scheduling period. These sets may be different, because the set of active data flows changes. Alternatively, the scheduling process may decide to allocate communication resources to different data flows among the active data flows.

It is appreciated that communication resources are typically divided into channels. Scheduling of communication resource thus typically refers to scheduling of channels to data flows. In communications, a channel is the path or route which a message follows, as the message is transmitted between a communication source and a receiver, distinguished from other parallel paths. In a time division multiplex system, for example, a channel is typically defined as a certain time slot. In a frequency division multiplex system, a channel is defined by a certain frequency. In a code division multiplex system, a channel is defined by a certain code.

With respect to multiple antenna transmissions, it is appreciated that the scheduled communication resources may comprise any of the following: single-input-single-output (SISO) channels, single-input-multiple-output (SIMO) channels, multiple-input-single-output (MISO) channels, and multiple-input-multiple-output channels (MIMO).

In the following embodiments, the communication resource scheduling functionality is split into two functional parts: a first part relates to managing the data to be transmitted using a set of communication resources and a second part relates to determining properties of the set of communication resources and to allocating the set of communication resources to users according to the communication resource properties and information about the data to be transmitted.

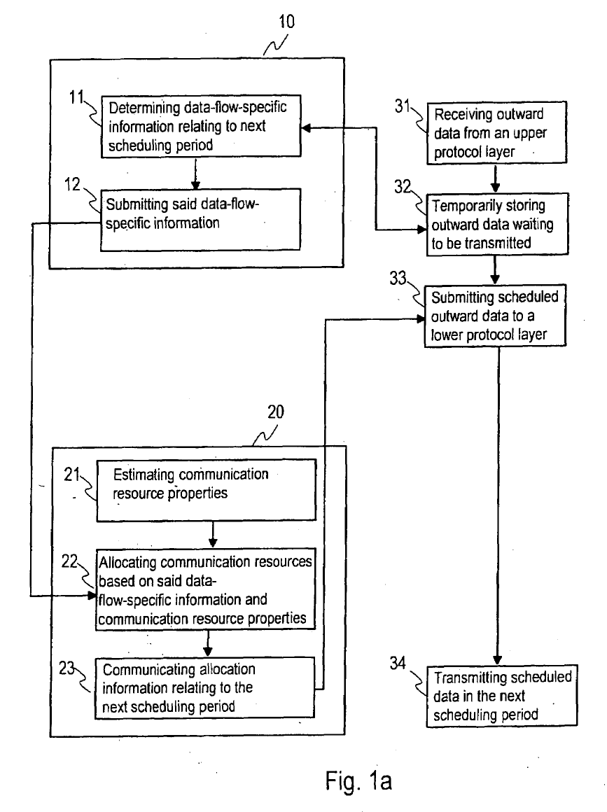

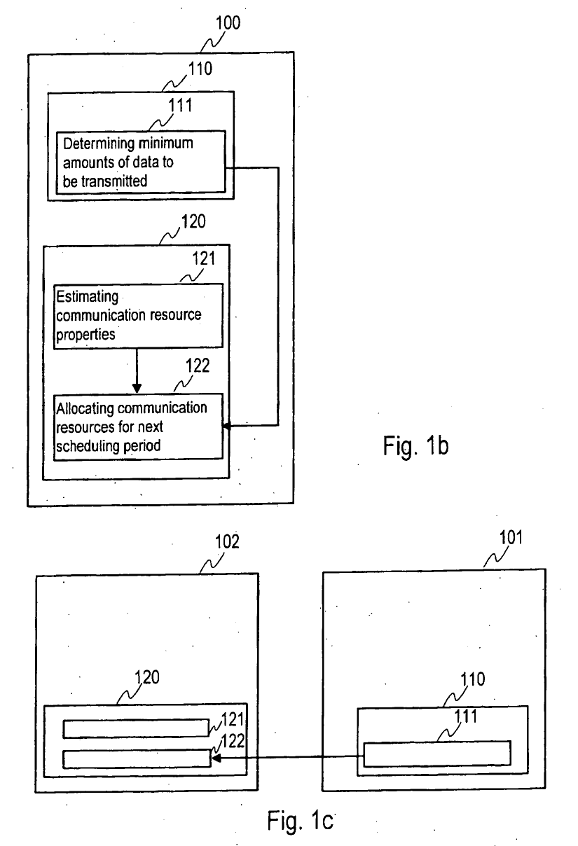

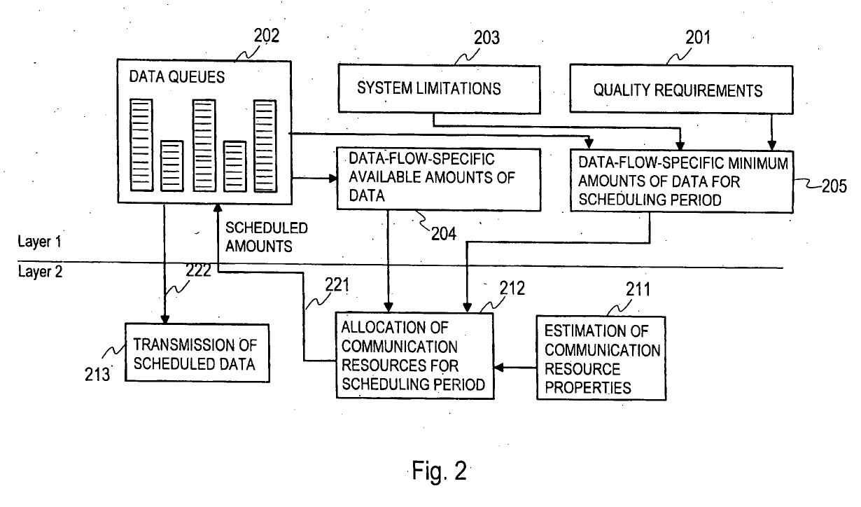

FIG. 1a shows a schematic block diagram relating to a first embodiment of the invention. Typically the data to be transmitted is received from an upper protocol layer and the data to be transmitted is stored temporarily when awaiting transmission (blocks 31, 32). Blocks 31 and 32 are typically part of the second (link) protocol layer L2. FIG. 1a shows a first entity 10, which typically is implemented in the second (link) protocol layer L2 or as part of the protocol layer L2, and a second entity 20, which typically is implemented in the first (physical) protocol layer L1 or as part of the protocol layer L1.

The first entity 10 determines data-flow-specific information relating to a next scheduling period for a set of data flows (block 11). In determining the data-flow-specific information, the amount of data awaiting transmission is typically checked. As discussed below, the data-flow-specific information may contain, for example, data-flow-specific minimum amounts of data to be transmitted in the next scheduling period and/or data-flow-specific available amounts of data awaiting transmission. It is, however, possible that other data-flow-specific parameters are determined in block 11. The data-flow-specific information is submitted (block 12) to the second entity 20.

In the second entity 20, communication resource properties are estimated (block 21). As the second entity 20 is typically part of the physical protocol layer, it has access to various information about the communication resources. The physical protocol layer L1 typically has access to all available information about the communication resource properties. The communication resources are allocated based on said data-flow-specific information and the determined communication resource properties (block 22). If the second entity 20 (that is, typically, a physical protocol layer entity) does not have direct access to the temporarily stored data in block 32, allocation information relating to the next scheduling period is communicated to block 33 (typically part of the link protocol layer entity L2) having access to the temporarily stored data. In block 33, scheduled outward data is then submitted to the physical protocol layer L1, and in block 34 the scheduled data is transmitted in the next scheduling period.

It is appreciated that when the second entity 20 is part of the physical protocol layer L1 and the temporary storage of outward data in block 32 is implemented so that the physical protocol layer L1 has access to the temporarily stored data, blocks 23 and 33 may be discarded.

FIG. 1b shows a schematic block diagram of a first alternative of the first embodiment of the invention. A network node 100 contains a first entity 110 and a second entity 120. The first entity 110 is configured to determine information about the amounts of data to be transmitted. These amounts of data to be transmitted are typically data-flow-specific minimum amounts of data to be transmitted within the next scheduling period. In addition, information about data-flow-specific amounts of available data may be determined and used in scheduling. Information about the amounts of data to be transmitted is submitted to the second entity 120. The second entity 120 is configured to estimate communication resource properties and to allocate communication resources to data flows based on at least the received information about the amounts of data to be transmitted and on the estimated communication resource properties.

It is appreciated that the allocation of communication resources in the second entity 120 may take into account further information than only data-flow-specific minimum amounts of data to be transmitted within the next scheduling period and estimated communication resource properties. As a first example, taking into account the data-flow-specific amounts of available data is mentioned above. This information is useful especially when the minimum amounts of data to be transmitted do not consume all transmission capacity within the next scheduling period. As a second example, for allocating sufficient quality communication resources to data flows, the second entity 120 may need information about error performance requirements of the data flows. As a third example, for ignoring low-priority data flows if not all minimum data requirements can be satisfied, information about priorities of the data flows may be needed in the second entity 120. As the error performance requirements and priority information typically does not change very rapidly, this information generally need not be communicated between the first entity 110 and the second entity 120 separately for each scheduling period. It is typically sufficient that the second entity 120 is informed, for example when transmitting first data packets relating to a data flow or when setting up a data flow, about error performance requirements and priority. Information about data-flow-specific amounts of information available for transmission and about data-flow-specific minimum amounts of information to be transmitted in the next scheduling period may change rapidly, so this information may be submitted to the second entity 120 for each scheduling period.

FIG. 1c shows a schematic block diagram of a second alternative of a first embodiment of the invention. In this second alternative, the first entity 110 is in a first network node 101 and the second entity 120 is in a second network node 102. The first network node 101 may be, for example, a base station of a communications system, and the second network node 102 may be a relay station. As a relay station is often connected to a base station with a radio interface, it is appreciated that it is not needed to transmit all possible quality requirement information to the second entity 120 for scheduling or, vice versa, to transmit information on estimated communication resource properties to the first entity 110.

Base station usually refers to a cellular communication system, but it is appreciated that embodiments of the present invention are applicable in any communications systems. Access nodes of wireless local area networks are one example of transceiver network elements, where the embodiments are applicable.

Information on communication resource quality is measured, stored and processed typically in the physical layer (L1). Quality of service information relevant to scheduling of traffic flows, on the other hand, is typically managed at the link layer (L2). The quality of service information includes e.g. priorities, delay budgets, queue lengths and/or packet error requirements. The proposed split of the scheduler functionality does not need excessive control information exchange between L1 and L2 layers.

Furthermore, the physical layer and the link layer are in practice often implemented on different processing platforms. The proposed split of the scheduler functionality supports this architecture and enables parallel processing on these two processing platforms.

As the instantaneous channel allocation decisions between users are made on the physical layer, or in the entity responsible for estimating communication resource properties, all available information on the communication resource properties is available for the scheduling decision.

In accordance with embodiments of the invention, the scheduling functionality is split between two entities, more particularly between two protocol layers. This proposed split enables implementation of different parts of the scheduler to different physical network nodes in a communication system.

Furthermore, in some embodiments of the invention it is possible to implement the proposed scheduling functionality within a single entity. In this case, at least block 12 in FIG. 1a can typically be discarded. Also in this case advantages are obtained from first determining user-specific amounts of data to be transmitted using various quality requirements and thereafter using this information about the amounts of data to be transmitted in making decisions about allocation of communication resources. The complexity of the scheduling algorithm is reduced compared to a situation where all information about the data amounts and quality requirements and information about the communication resource properties would be processed at one go.

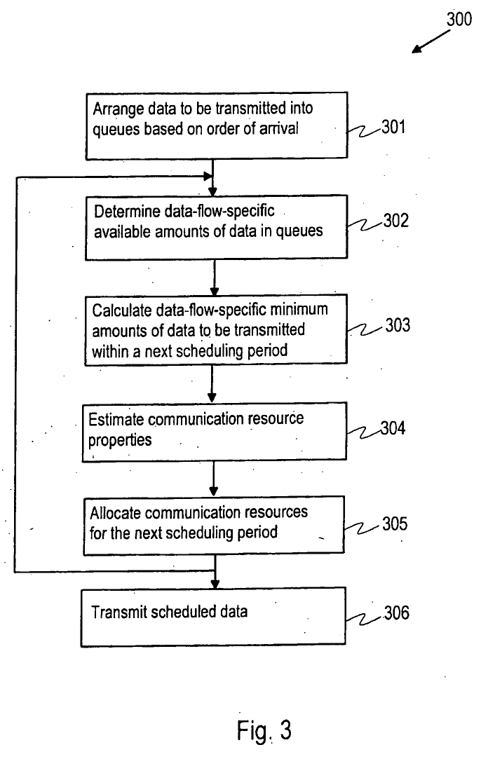

FIG. 2 shows, as an example, a schematic diagram of two lowest protocol layers L1 and L2 in accordance with a second embodiment of the invention. It is, however, appreciated that all functionality shown in FIG. 2 may be implemented in a single entity.

In FIG. 2, the data link layer L2 has received service-specific quality requirement information 201 from upper protocol layers. Typically this quality requirement information is a set of QoS parameters. Quality requirement information typically consists of, but is not limited to, maximum packet delay, priority information, and error performance requirement. The error performance requirement may be, for example, a maximum bit error rate (BER) or block error rate (BLER). A data flow typically relates to a service, and the quality requirements for a data flow are typically the same as those for the service. Multiple data flows may relate to a single service.

Based on the QoS parameters and the arrival order of data packets from upper protocol layers, the data packets can be arranged into queues 202. These queues may be specific to sets of QoS parameters, and therefore data packets in one queue have the same quality requirements. If priority information is to be taken into account in scheduling, each queue may have a specific combination of QoS parameters and priority.

Knowing the time each packet has spent in the queue and the delay budget specified by the quality requirements, the minimum amount of data to be transmitted for each data flow within the next scheduling period (block 205 in FIG. 2) can be calculated. Typically there are also system limitations 203, which may affect the calculation of the minimum or maximum amount of data that should be transmitted within the next scheduling period. An example of such system limitations is the maximum length of a queue. It is also possible to determine that data-flow-specific available amounts of data, in other words the amount of data in each queue (block 204 in FIG. 2). The data-flow-specific minimum amounts of data, the data-flow-specific amounts of data available in the queues and the error performance requirements for each data flow will be transferred to L1.

The physical layer L1 estimates the communication resource properties (block 211). As an example of handling transmission diversity or multiplexing, it is possible to measure channel qualities relating to a first path/carrier and to a second path/carrier for a specific data flow. The allocation of communication resource may then take into account, for example, five possibilities to transmit information relating to the data flow: the first path/carrier, the second path/carrier, multiplexing data through both paths/carriers, a diversity transmission using both the first and the second path/carrier, or some transmission combining the elements of multiplexing and diversity.

The allocation of communication resource for the next scheduling period (block 212) is based at least on estimated communication resource properties and on data-flow-specific minimum amounts of data to be transmitted within the next transmission period. Typically also the data-flow-specific amounts of data available for transmission are also used as input to the allocation. As discussed above in connection with FIG. 1, also error performance requirements and priority information may be used in making allocation decisions. The physical layer L1 typically primarily ensures that the minimum requirements are efficiently met. A first criterion used in the allocation thus relates to meeting the user-specific minimum amounts of data to be transmitted in the next scheduling period. As a secondary criterion the physical layer L1 uses efficient use of the remaining communication resources. The remaining capacity of the system, after the data-flow-specific minimum requirements are met, may be allocated by maximizing the throughput and taking into account the quality of the channel for each data-flow. Instead or in addition to maximizing the throughput L1 can aim to minimize the power consumption, or the error probability of the transmission. Also the time variation of the channel of each data flow, and/or the accuracy of the channel estimation during the next scheduling period can be used as criterion for scheduling. For example for data flows with quickly varying channels the channel estimation based on the training symbols transmitted on periodic intervals is not accurate for shorter time than for the data flows with slowly varying channels. If the training symbols are sent for example in the beginning of the scheduling period it is advantageous to allocate data flows with quickly varying channels in the beginning of the scheduling period, whereas data flows with more stable channel conditions can be scheduled at the end of the scheduling period to prevent loss of accuracy in the channel estimation for each data flow. It is furthermore possible that the communication resources are allocated in a manner which provides a balance between various criteria mentioned above.

Once the scheduling for the next scheduling period is determined, the physical layer L1 sends the information about the scheduled amounts of data (arrow 221) to the data link layer L2. These scheduled amounts of data are typically queue specific. The data link layer L2 sends data (arrow 222) from the queues in accordance with the scheduled amounts to the physical layer L1. Based on the scheduled amounts of data, on new incoming data and on other relevant information (for example, quality requirements 201 and system limitations 203) the data link layer L2 then determines corresponding input parameters 204, 205 for the following scheduling period.

It is appreciated that the specific way how the physical layer L1 allocates communication resources for the next scheduling period depends on the communications system. The scheduling should be optimized depending, for example, on possible multicarrier modulation, multiple access scheme, duplexing, frame structure, used modulation alphabets and/or coding schemes, or propagation environments.

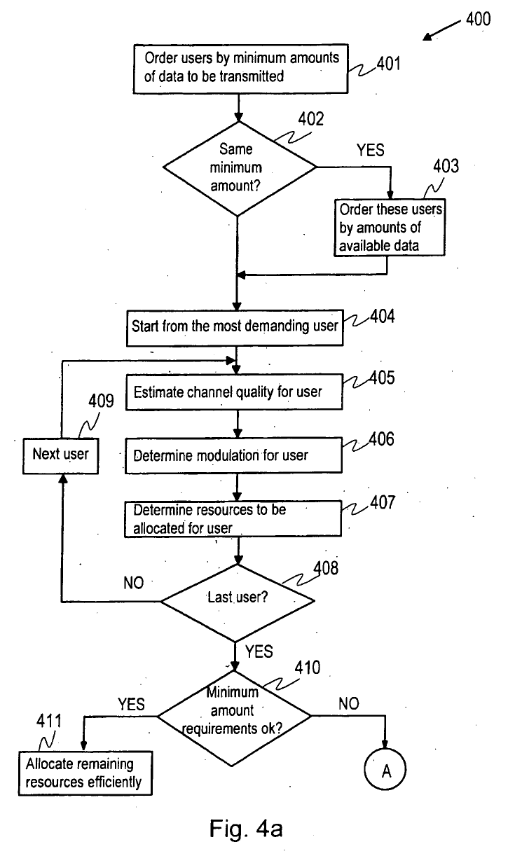

FIG. 3 shows, as an example, a flowchart of a method 300 in accordance with a third embodiment of the invention. In step 301, which is carried out continuously, data packets to be transmitted are arranged into queues based on the order of their arrival from the upper protocol layers. In step 302, the data-flow-specific amounts of data available to be transmitted are determined. In step 303, the data-flow-specific minimum amounts of data to be transmitted within a next scheduling period are calculated. Steps 301 to 303 typically take place in the link layer L2. In step 304, communication resource properties are estimated. In step 305, communication resources are allocated for the next scheduling period based on the data-flow-specific minimum amounts of data, data-flow-specific available amounts of data and on the estimated communication resource properties. In step 306, the scheduled data is transmitted using the allocated communication resources. For the following scheduling period, the method 300 continues from step 302 with updated information about the data packets in the queues.

It is appreciated that although FIGS. 2 and 3 and the corresponding description occasionally refer to arranging data packet into user-specific queues or QoS-set-specific queues, other implementations may also be feasible.

In the following some possible modifications to embodiments of the invention are discussed. The minimum amount of data to be transmitted within the next scheduling period, in other words the bit rate, may be set to zero, even for all data flows, if all the packets in the queues are still within the set delay limits during the next scheduling period in question. In this case the allocation for the next scheduling period can use, for example, capacity, throughput, error rate or power optimized scheduling between the users. One example of throughput optimized scheduling is the maximum C/I scheduling discussed above in connection with the related background art.

It would be possible to indicate in the link layer L2 a small minimum amount of data to be transmitted within the next scheduling period even for best-effort data. This way a continued data flow would be created for best-effort data even when higher-priority data exists to by-pass the non-real-time information.

The L2 scheduling can be also set up so that it selects only some subset of data flows to be scheduled for the scheduling period in question. This decision can be done for example based on: delay requirements, amount of data in the queues, and/or error performance requirements. For example, a set of data flows with similar delay requirements or error performance requirements may be selected from a larger number of data flows. This can be useful because there usually exists some upper limit on the number of data flows who can be served during one scheduling period. Alternatively or additionally, selecting a subset of data flows may be useful to reduce the complexity of the L1 scheduling between excessively many data flows, and to reduce the signaling required to inform the users on when they are scheduled for transmission or reception.

When calculating the minimum bit rate requirements for the next scheduling period the link layer L2 can also take into account not only the delay requirements but also the amount of data in the buffer. This is to avoid situations where satisfying only the minimum requirements will lead into a congested situation later on. Also the realized bit rates for each user (that is the scheduled amounts of data), averaged over some suitable time period, could be used in L2 to estimate the future capacity of each user's channel or at least of one of the user's channel. This could be useful in trying to optimize the L2 processing.

In communication systems with multi-hop network topology the distributed scheduling can be particularly useful. As an example, in systems with base stations (BS) and relay stations (RS) the L2 part of the scheduling can be done only in the base station, which sends information required for the L1 scheduling discussed above to the relay station via a radio interface. The relay station can then do the L1 scheduling as deemed suitable without requiring knowledge of all the L2 parameters. In these types of situations where either the control information on L2 or the channel information on L1 will have to be sent over air the distributed scheduling saves radio resources and makes delays shorter, while allowing for the channel qualities to be used as basis for scheduling.

The specific way on how the L1 processing is done depends crucially on the particular radio interface used. In particular the single/multicarrier modulations, spatial structure of the channel (for example, MIMO vs. SISO transmissions), multiple access scheme and frame structure need to be taken into account. Some examples of implementation are discussed below.

A fourth embodiment of the invention relates to a system where single carrier modulation is used and where no spatial multiplexing is used. This means that the system uses single-input-single-output (SISO) or single-input-multiple-output (SIMO) transmission. The channel quality, and therefore the bit rate for the channel, are determined by the carrier to interference ratio C/I of the channel. With a single carrier, the users for the next scheduling period can be multiplexed either in time direction or by using spreading codes.

In discussing this fourth embodiment, it is assumed that there is at most one data flow relating to each user. It is evident to a skilled person how to modify this fourth embodiment to cover also the possibility of multiple data flows relating to a user.

In this fourth embodiment the L1 scheduling first tries to multiplex all the users with non-vanishing minimum amounts of data to be transmitted within the next scheduling period using the resources available. After satisfying the non-vanishing minimum requirements, the rest of the resources (time instants, spreading codes) are allocated to the users with best channels and/or largest amounts of available data to be transmitted.

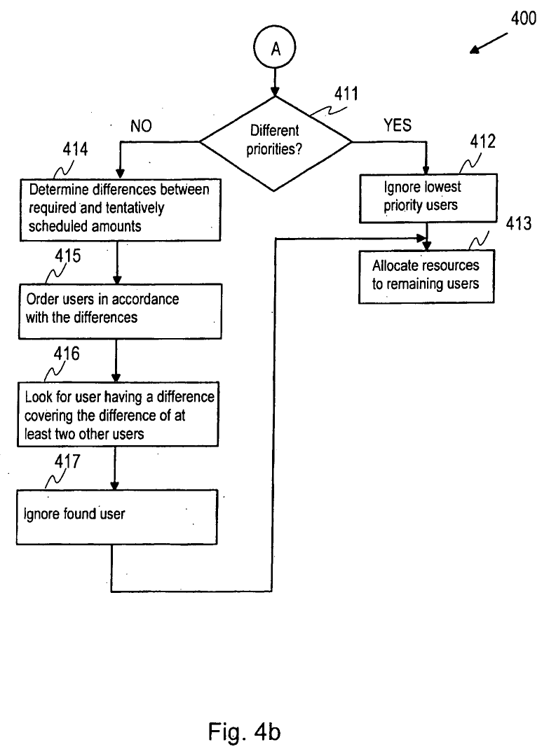

FIG. 4A shows some details of a L1 scheduling method 400 in accordance with the fourth embodiment. In step 401, the users are ordered by their minimum amount of data to be transmitted within the next scheduling period. If two or more users have the same minimum amount of data to be transmitted within the next scheduling period (step 402), these users are ordered according to the amount of available data, in decreasing order in step 403. In steps 404-409, time slots/spreading codes are allocated to the users starting from the most demanding user (step 404) and in the order defined (step 409). The resources are allocated so that the most demanding user is satisfied first, then the next users. If adaptive modulation is used, the channel quality for each user in turn is evaluated in step 405 and the modulation determined accordingly in step 406. The selected modulation affects the need for time slots/spreading codes, so the amount of allocated resources is determined thereafter in step 407. If the scheduling method 400 is successful (step 410) and the minimum amounts of data can be scheduled for all users, the excess capacity should be utilized effectively (step 411).

For example, all the users (even those without minimum amounts of data to be transmitted within this scheduling period) can now be ordered according to their channel quality, and resources may be allocated in that order, trying to satisfy the maximum amounts of data, possibly using adaptive modulation. It is appreciated that depending, for example, on the modulation and frame structure, there might be some preferred granularity in the amounts of data that can be allocated. This granularity should be taken into account to avoid gaps.

FIG. 4B shows continuation for the method 400. If not all users can be satisfied, the users with lower priority (if any) are dropped first in step 412 by ignoring them. Thereafter the method 400 may carry out steps 404 to 409 again, or use information available from the previous round of steps 404 to 409 to determine allocation of resources to the remaining (higher-priority) users in step 413. If no difference in priorities exists, then the largest possible number of users should be satisfied. Several different alternatives exist on how to do this. FIG. 4b shows, as an example, how user-specific differences between the required minimum data amounts and the tentatively scheduled data amounts are determined (step 414). In step 415, the users are ordered in accordance with these differences in an ascending order, starting from the user with the smallest difference between the required and tentatively scheduled data amount. Starting from the user with the smallest difference and the user with the next smallest difference, one looks in step 416 for a user having enough tentatively scheduled data to cover the differences of these two or more users. When a user having enough tentatively scheduled amount of data covering the differences of at least two other users is found, this user is ignored in step 417. If no such user can be found, the user with enough tentatively scheduled data to cover the smallest difference is dropped, starting the search from the user with the largest difference This procedure can be repeated, if needed. Thereafter the communications resources are allocated for the remaining users in step 413.

It is appreciated that various modifications to the implementation shown in FIGS. 4A and 4B are possible.

Regarding multicarrier modulation, which means that multiplexing can be done in time and in frequency/subcarriers, there may be need to develop existing allocation methods further. Existing capacity/throughput optimized multicarrier allocation methods satisfying minimum data rates for users may be applied, but they usually do not take into account the fact that there can also be upper limits on the amounts of data. Moreover, the optimal solutions may be computationally very complex for a large number of subcarriers, so effective suboptimal algorithms with minimum and maximum constraints may need to be developed.

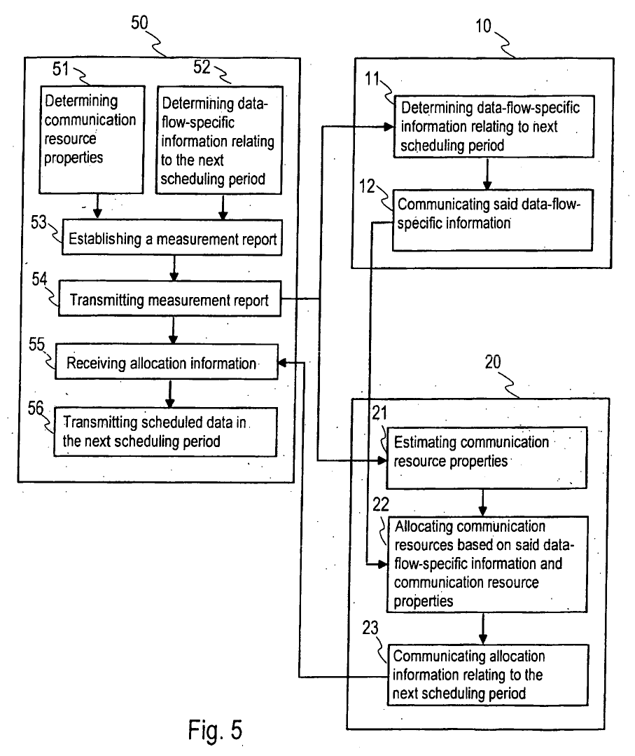

It is appreciated that in addition to downlink and other systems controlled by the transmitting entity, a more restricted version of the scheduler functionality may be implemented in uplink or otherwise in a node, which is not in control of communication resource allocation. FIG. 5 shows schematic example. A (communications device 50 may determine communication resource properties in block 51 and may send in the uplink direction a measurement report to the network (blocks 53, 54). Typically the measurement report contains information about downlink communication resource properties, but if the communications device is able to estimate also uplink communication resource properties, information on the uplink properties may be included in the measurement report. The downlink communication resource property information may not be needed in block 21 but, as FIG. 5 shows, the measurement reports may be used as an input for block 21. The communications device 50 may also determine data-flow-specific information relating to a next scheduling period (block 52). The measurement report includes data-flow-specific information, for example information about the minimum amounts of data and about available data for its data flow(s), to assist the network in arbitrating the allocation of uplink communication resources between different communications devices. Alternatively, the data-flow-specific information may be transmitted to the network separately from the measurement report. The minimum amounts of data to be transmitted within the next scheduling period and the available amounts of data may be arranged to some priority classes. In the network there is an uplink scheduling function, which contains both the L1 and the L2 scheduling features discussed above (entities 10 and 20 in FIG. 5). These features may, however, need not be implemented in the L1 and L2 layers, but they may be implemented, for example, in one layer. The uplink scheduling function estimates the uplink communication resource properties (block 21), for example, based on the measurement reports and/or based on other information available to it. The uplink scheduling function allocates the uplink communication resources for the uplink data flows (block 22). The uplink scheduling function then indicates (block 23) the resource allocation to the communications devices. The communications devices, in turn, transmit data in accordance with the uplink resource allocation (blocks 55, 56).

It is appreciated that any method in accordance with the embodiments of the present invention may be implemented in devices, more particularly in network elements or in communications devices for use with communications systems.

It is appreciated that embodiments of the invention may be implemented using software, hardware or a suitable combination of these. For example, embodiments of the invention may be implemented using Application-Specific Integrated Circuits (ASICs), designed for particular applications. As a second example, embodiments of the invention may be implemented using program code for programmable Digital Signal Processing (DSP) chips.

It is appreciated that the term data flow in this description and in the appended claims is to be understood to refer to a set of data, for example to a connection, with specific quality requirements. As mentioned above, there may be multiple data flows relating to a single user.

It is furthermore appreciated that the term user need not refer to human users. The term may refer to any process or equipment having data to transmit.

As mentioned also above, it is appreciated that the specific way how the scheduling of communication resources is carried out given the minimum amounts of data to be transmitted within a scheduling period and the available amounts of data to be transmitted depends on the set of communication resources.

It is appreciated that a part of the communication resources may be left unallocated during a scheduling period, especially if the amounts of data available for transmission are not sufficient to use all available communication resources.

It is furthermore appreciated that the term communication resource properties may refer to various properties. For example, when a single carrier modulation is used together with no spatial multiplexing, the communication resource properties are defined by the carrier to interference ratio C/I of a channel. It is evident to a skilled person that communication resource properties for diversity schemes or, for example, for MIMO systems may be defined by a number of quality factors.

It is appreciated that the term data-flow-specific information relating to a next scheduling period typically refers to sets of parameters, the parameters having data-flow-specific values.

Embodiments of the invention would have merits in any environment, where due to diversity multiple more or less independent channels are created between two transceiver stations. These environments include all present and future multicarrier systems and possible other not-yet-specified systems using e.g. antenna diversity approaches. Some example of multicarrier systems are 802.11a and some other branches of WLAN; WiMax; WiBro; possible multicarrier extensions in 3GPP and 3GPP2; and Ultra Wideband (UWB) family.

It is appreciated that although this description refers in many instances to two entities involved in the scheduling, and more specifically to L1 and L2 layers, the scheduling functionality may be implemented in a single entity.

In the appended claims term submitting information refers to delivering information to a further entity, either within the same device (for example, between protocol layer entities) or to a further device. An example of submitting information within one device is information delivery between protocol entities in the given device. Some examples of submitting information between devices are, firstly, the base station and relay station combination and, secondly, the communications device and a network element of a communications system in the restricted version of scheduler functionality.

Although preferred embodiments of the apparatus and method embodying the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

1. A method for scheduling communication resources, the method comprising
determining data-flow-specific information relating to a next scheduling period for a set of data flows in a first entity,
submitting said data-flow-specific information to a second entity,
estimating communication resource properties for communication resources in said second entity, and
allocating said communication resources in the next scheduling period based at least on said data-flow-specific information and said communication resource properties in said second entity.

2. A method as defined in claim 1, comprising selecting said set of data flows from a larger set of data flows.

3. A method as defined in claim 2, wherein said set of data flows is selected based on at least one of the following: delay requirements, available amounts of data to be transmitted, and error requirements.

4. A method as defined in any one of claim 1, wherein said data-flow-specific information comprises at least one of the following: minimum amount of data to be transmitted for a data flow, and available amount of data to be transmitted for a data flow.

5. A method as defined in claim 4, wherein at least one of the following is taken into account in allocating said communication resource for the next scheduling period: data-flow-specific priorities, data-flow-specific delay requirements, and data-flow-specific error requirements.

6. A method as defined claim 4, wherein said data-flow-specific information comprises at least one of the following: priorities, delay requirements, and error requirements.

7. A method as defined in claim 4, comprising calculating said data-flow-specific minimum amounts of data based at least on one of the following: priorities, remaining number of retransmissions, delay requirements and available amounts of data to be transmitted.

8. A method as defined in claim 4, comprising setting the data-flow-specific minimum amounts of data to be transmitted to zero when data-flow-specific delay requirements are met.

9. A method as defined in claim 4, comprising setting a minimum amount of data to be transmitted to be larger than zero for best-effort data.

10. A method as defined in claim 4, comprising averaging data-flow-specific scheduled amounts of data to be transmitted over scheduling periods for at least one data flow.

11. A method as defined in claim 10, comprising estimating transmission capacity for said at least one user.

12. A method as defined in claim 4, comprising allocating said communication resources based on a first criterion relating to meeting said data-flow-specific minimum amounts of data to be transmitted.

13. A method as defined in claim 4, comprising allocating said communication resources based on a first criterion relating to meeting said data-flow-specific minimum amounts of data and a second criterion relating to an efficient use of communication resources.

14. A method as defined in claim 13, wherein said second criterion relates to at least one of the following: maximizing the amount of data to be transmitted within the next scheduling period, minimizing transmission power within the next scheduling period and minimizing transmission error probability within the next scheduling period.

15. A method as defined in claim 13, comprising allocating communication resources first in accordance with said first criterion and allocating the remaining communication resources in accordance with said second criterion.

16. A method as defined in claim 13, comprising prioritizing data flows when scheduling communication resources to said set of data flows using said first criterion.

17. A method as defined in claim 13, comprising allocating said communication resources based on a third criterion relating to maximizing the number of data flows whose data-flow-specific minimum amounts of data are met.

18. A method as defined in claim 1, comprising ordering data flows of said set of data flows in an order relating to data-flow-specific minimum amounts of data for allocating communication resources in said order, starting from the data flow having the highest minimum amount of data to be transmitted within the next scheduling period.

19. A method as defined in claim 18, comprising ordering data flows having the same minimum amount of data to be transmitted in an order relating to said data-flow-specific available amounts of data to be transmitted.

20. A method as defined in claim 1, comprising determining adaptive modulation for data flows after allocating communication resources to said set of data flows.

21. A method as defined in claim 1, wherein said allocating takes into account at least one of the following: multicarrier modulation, multiple access scheme, duplexing, frame structure, modulation alphabets, and coding schemes.

22. A method as defined in claim 1 comprising receiving at least a piece of data-flow-specific information relating to the next allocation period from at least one communications device.

23. A method as defined in claim 22, comprising transmitting to said at least one communications device information about scheduled amounts of data for the next scheduling period.

24. A method as defined in claim 1, comprising transmitting data belonging to said set of data flows in accordance with scheduled amounts of data in the next scheduling period.

25. A method for scheduling communication resources, the method comprising
determining data-flow-specific information relating to a next scheduling period for a set of data flows, and
submitting said data flow-specific information to a further entity for allocating communication resources in the next scheduling period in said further entity based at least on said data-flow-specific information and on estimated properties of said communication resources.

26. A method as defined in claim 25, comprising receiving information indicating scheduled amounts of data.

27. A method as defined in claim 26, comprising transmitting data to be transmitted within the next scheduling period in accordance with said information indicating scheduled amounts of data.

28. A method as defined in claim 25, wherein said data-flow-specific information comprises at least one of the following: minimum amount of data to be transmitted for a data flow, and available amount of data to be transmitted for a data flow.

29. A method as defined in claim 28, wherein the minimum amount of data is derived taking into account at least one of the following: priorities, remaining number of retransmissions, delay requirements and available amounts of data to be transmitted.

30. A method for scheduling communication resources, the method comprising
receiving from a further entity data-flow-specific information relating to a next scheduling period for a set of data flows,
estimating communication resource properties for communication resources, and
allocating said communication resources in the next scheduling period based at least on said data-flow-specific information and said communication resource properties.

31. A method as defined in claim 30, wherein said data-flow-specific information comprises at least one of the following: minimum amount of data to be transmitted for a data flow, and available amount of data to be transmitted for a data flow.

32. A method as defined in claim 30, comprising transmitting information indicating scheduled amounts of data to said further entity.

33. A method as defined in claim 30, comprising receiving data to be transmitted within the next scheduling period from said further entity.

34. A method as defined in claim 30, comprising transmitting data to be transmitted within the next scheduling period over said set of communication resources in accordance with said scheduling.

35. A device for scheduling communication resources, said device being configured to
determine data-flow-specific information relating to a next scheduling period for a set of data flows in a first entity,
submit said data flow-specific information to a second entity,
estimate communication resource properties in communication resources in the second entity, and
allocate said communication resources in the next scheduling period based at least on said data-flow-specific information and said communication resource properties in the second entity.

36. A device as defined in claim 35, comprising a network element for a communications system.

37. A communications system configured to
determine data-flow-specific information relating to a next scheduling period for a set of data flows in a first entity,
submit said data-flow-specific information to a second entity,
estimate communication resource properties for communication resources in the second entity, and
allocate said communication resources in the next scheduling period based at least on said data-flow-specific information and said communication resource properties in the second entity.

38. A device for scheduling communication resources, said device being configured to
receive from a further entity data-flow-specific information relating to a next scheduling period for a set of data flows,
estimate communication resource properties for communication resources, and
allocate said communication resources in the next scheduling period based at least on said data-flow-specific information and said communication resource properties.

39. A device as defined in claim 38, comprising a network element for a communications system.

40. A device as defined in claim 38, comprising a relay network element for a communications system.

41. A device for scheduling communication resources, said device being configured to
determine data-flow-specific information relating to a next scheduling period for a set of data flows, and
submit said data-flow-specific information to a further entity for allocating communication resources in the next scheduling period in said further entity based at least on said data-flow-specific information and on estimated properties of said communication resources.

42. A device as defined in claim 41, comprising a network element for a communications system.

43. A device as defined in claim 41, comprising a transceiver network element for a communications system.

44. A device as defined in claim 41, comprising a communications device for communicating via a communications network.

45. A device as defined in claim 44, configured to receive information about scheduled data amounts for the next scheduling period.

46. A device as defined in claim 45, configured to transmit data in accordance with the scheduled data amounts in the next scheduling period.

47. A device as defined in claim 44, configured to transmit measurement reports indicating transmission resource properties to the further entity.

48. A communications system comprising a first device as defined in any one of claims 38 to 40 and a second device as defined in claim 47.

49. A computer program comprising program instructions for causing a computing device to perform the method of claim 25.

50. A computer program as defined in claim 49, embodied on a record medium or stored in a memory of a computing device.

51. A computer program comprising program instructions for causing a computing device to perform the method of claim 30.

52. A computer program as defined in claim 51, embodied on a record medium or stored in a memory of a computing device.

53. A method for scheduling communication resources, said method comprising
determining data-flow-specific information relating to a next scheduling period for a set of data flows,
estimating communication resource properties for communication resources, and
allocating said communication resources in the next scheduling period based at least on said data-flow-specific information and said communication resource properties.

54. A device configured to
determine data-flow-specific information relating to a next scheduling period for a set of data flows,
estimate communication resource properties for communication resources, and
allocate said communication resources in the next scheduling period based at least on said data-flow-specific information and said communication resource properties.
